(19) United States
(12) Patent Application Publication
(10) Pub. No.: US 2026/0110145 A1
(43) Pub. Date: Apr. 23, 2026

(54) QUICK SETTING POLYMERIC MODIFIED CEMENT COMPOSITIONS FOR POTHOLE REPAIR

(71) Applicant: W. Robert Wilson, Boonton, NJ (US)

(72) Inventor: W. Robert Wilson, Boonton, NJ (US)

(21) Appl. No.: 18/921,106

(22) Filed: Oct. 21, 2024

(51) Int. Cl. E01C 11/00; C04B 24/24; C04B 28/06; C04B 111/00

(52) U.S. Cl. CPC E01C 11/005; C04B 24/24; C04B 28/06; C04B 2111/00146; C04B 2111/0075

(57) ABSTRACT

A method for providing a quick setting polymer modified cement composition within a pothole in a vehicular trafficked pavement substrate. The method includes preparing a wet polymer modified cement mixture by mixing a dry mixture including a cement, an aggregate, and a polymer in particulate form with a water-containing liquid. The quick setting polymer modified cement composition is prepared by mixing the wet polymer modified cement mixture with a quick setting (calcium aluminate cement) mixture (in wet or dry form). The quick setting mixture may be mixed with the wet polymer modified cement mixture in a mixer followed by providing the quick setting polymer modified cement composition to the potholes. Alternatively, the quick setting mixture may be mixed by providing (spraying) the quick setting mixture into the wet polymer modified cement mixture as it is being applied to the pothole. Topical items may be provided thereonto.

### BACKGROUND

Pavement substrates are constructed to carry traffic such as vehicles (e.g., automobiles, bikes, construction equipment). Pavement structures are typically asphalt or concrete. The wear and tear of the traffic and impacts of weather (e.g., sunlight, precipitation, temperature changes) often cause the pavement substrates to be degraded. The degradation may come in the form of cracks or holes of various sizes (“potholes”). The potholes may cause damage to vehicles that hit the potholes and/or may result in accidents as vehicles swerve to miss the potholes or lose control when hitting the potholes.

Asphalt is often used to fix potholes in pavement substrates. The pothole is cleaned of debris and the asphalt is prepared and placed in the pothole. Typically, the asphalt overfills the pothole and then the asphalt is rolled over to compress the asphalt and align it with the pavement substrate. If the pothole repair is done correctly the asphalt fix may bond with an asphalt pavement substrate. However, the bond may not be a permanent bond. Accordingly, over time the asphalt fix may shift within the pothole and eventually break apart and come out of the pothole.

Regardless of how the repair is done, the asphalt fix will not bond with the concrete substrate so an asphalt fix is only ever used as a temporary fix with concrete pavement substrates. Permanent repairs to concrete substrates require the use of a concrete patch. Depending on various conditions, including the temperature and humidity, it may take a substantial amount of time for the concrete placed within the pothole to cure sufficiently so that traffic can pass thereover. Allowing the traffic to drive over the pothole repair too soon may result in damage to the repair as well as spreading the concrete to the vehicle or other portions of the trafficked substrate.

What is needed is a material that can be used to fix potholes in both asphalt and concrete pavement substrates that cures quickly, bonds to the underlying substrate and is capable of supporting the traffic that traverses thereover.

### BRIEF DESCRIPTION OF THE DRAWINGS

The following figures are meant to reflect specific embodiments of the invention and are not intended to otherwise limit the scope of the invention as described herein.

FIG. 1 illustrates an exemplary process for preparing a quick setting polymer modified cement composition, according to one embodiment;

FIG. 2 illustrates an alternative exemplary process for preparing a quick setting polymer modified cement composition, according to one embodiment;

FIG. 3 illustrates an exemplary process flow for applying a polymer modified cement composition to a substrate to pix potholes within the substrate, according to one embodiment;

FIG. 4 illustrates an exemplary vehicle configured to house components necessary to prepare and apply a quick setting polymer modified cement composition according to the process described with respect to FIG. 1, according to one embodiment;

FIG. 5 illustrates an alternative exemplary vehicle configured to house components necessary to prepare and apply a quick setting polymer modified cement composition according to the process described with respect to FIG. 1, according to one embodiment;

FIG. 6 illustrates an exemplary vehicle configured to house components necessary to prepare and apply a quick setting polymer modified cement composition according to the process described with respect to FIG. 2, according to one embodiment; and

FIG. 7 illustrates an alternative exemplary vehicle configured to house components necessary to prepare and apply a quick setting polymer modified cement composition according to the process described with respect to FIG. 2, according to one embodiment.

### DETAILED DESCRIPTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Unless defined otherwise, all terms used herein have the same meanings as commonly understood by one of ordinary skill in the art to which this invention belongs. Specific compositions and methods are described, although any materials and methods similar or equivalent to those described herein can be used in the practice or testing of the present invention.

Present embodiments relate to a polymer modified cement mixture that can be used for pothole repair. Preferrable embodiments relate to quick setting polymer modified cement composition that can be used for pothole repair that are traffic ready a short time after application. The polymer modified cement composition may have excellent initial and long-term bonding to substrates. It is contemplated that the polymer modified cement composition may not soften at elevated temperatures or embrittle at lower temperatures and may be resistant to traffic and weathering. It is further contemplated that the polymer modified cement composition may also function as an adhesive layer (similar to epoxy, polyurethane, and bitumen) where objects may be partially or wholly received thereby and secured therein once cured.

According to one embodiment, the quick setting polymer modified cement composition includes a polymer modified cement mixture and a quick setting mixture. The quick setting mixture when mixed with the polymer modified cement mixture causes the polymer modified cement mixture to harden to the point of being able to receive traffic in a relatively short time. The polymer modified cement mixture dry mix includes a cement (e.g., ordinary Portland cement), an aggregate, a polymer, and optionally one or more components including, but not limited, to microfibers, plasticizers, fillers, accelerators, retarders, pigments, and mixtures thereof. The dry mix is mixed with a water-containing liquid to create a wet (e.g., aqueous) polymer modified cement mixture. The use of wet polymer modified cement mixtures as thin overlays on trafficked substrates are well-known in the art and are described in, for example, U.S. Pat. Nos. 8,784,557, 10,221,527, 10,654,751, U.S. Pat. Pub. No. 2022/0098123, and U.S. Pat. Pub. No. 2023/0312420, the entire contents of all of which are incorporated herein by reference.

It is contemplated that based on the total amount of the dry mix of the polymer modified cement mixture, the proportion of the cement may be between 30-60 wt. %, between 35-55 wt. %, or between 40-50 wt. %, the proportion of the aggregate may be between 30-60 wt. %, between 35-55 wt. %, or between 40-50 wt. %, the proportion of the polymer may be between 2-12 wt. %, between 3-10 wt. %, or between 5-8 wt. %, and the proportion of the one or more optional components may be between 0.5-9 wt. %, between 1-7 wt. %, or between 2-5 wt. %. The water containing liquid may be present in an amount between 13-26 wt. %, between 14-24 wt. %, or between 16-20 wt. % of the dry mix of the polymer modified cement mixture.

The quick setting mixture may include a dry mix that includes a cementitious agent and optionally an aggregate and/or a polymer. In certain embodiments, the cementitious agent is an amorphous cementitious agent. As used herein, the term “amorphous” means the substantial absence of crystallinity, e.g., solid structures having less than 5% or less than 1% crystallinity. The dry mix may be mixed with a water-containing liquid to create a wet (e.g., aqueous) quick setting mixture. Alternatively, the dry mix of the quick setting mixture may be mixed into the wet polymer modified cement mixture to create the quick setting polymer modified cement composition.

In some embodiments, based on the total amount of the dry mix of the quick setting mixture, the proportion of the cementitious agent may be 100 wt. %. In further embodiments, based on the total amount of the dry mix of the quick setting mixture, the proportion of the cementitious agent may be between 80-98 wt. %, between 83-95 wt. %, or between 86-92 wt. %, and the proportion of the polymer may be between 2-20 wt. %, between 5-17 wt. %, or between 8-14 wt. %. In even further embodiments, based on the total amount of the dry mix of the quick setting mixture, the proportion of the cementitious agent may be between 30-60 wt. %, between 35-55 wt. %, or between 40-50 wt. %, the proportion of the polymer may be between 2-12 wt. %, between 3-10 wt. %, or between 5-8 wt. %, and the proportion of the aggregate may be between 30-60 wt. %, between 35-55 wt. %, or between 40-50 wt. %. If a wet quick setting mixture is formed, the water containing liquid may be present in an amount between 35-70 wt. %, between 40-60 wt. %, or between 45-55 wt. % of the dry mix of the quick setting mixture.

In some embodiments, the water-containing liquid used to create the wet polymer modified cement mixture and the water-containing liquid used to create the wet quick setting mixture are the same. In some embodiments, a wet quick setting mixture is not created so a water-containing liquid is not used alone with quick setting mixture. Rather the quick setting mixture is mixed with the wet polymer modified cement mixture to create the quick setting polymer modified composition. In alternative embodiments, the water-containing liquid used to create the wet polymer modified cement mixture and the water-containing liquid used to create the wet quick setting mixture are different.

In certain embodiments, the polymer of the polymer modified cement mixture is a dry polymer. In a preferred embodiment, the polymer is in particulate (e.g., powder) form. The polymer may include one or more polymer compounds of monomer units, one or more copolymer compounds of monomer units, one or more terpolymer compounds of monomer units, and/or mixtures thereof. It is contemplated that the monomer units may include but are not limited to acrylic monomers, stearyl acrylate monomers, styrene acrylic monomers, vinal acetate monomers, vinyl acetate ethylene monomers, vinyl chloride ethylene monomers, polyvinyl acetate monomers, styrene-butadiene resins, and/or mixtures thereof.

The aggregate of the polymer modified cement mixture may be a coarse material or a fine material or even an ultrafine material. The aggregate may be a material selected from the group consisting of marble dust (one of ordinary skill in the art will appreciate that marble dust includes compounds in particulate form having greater than or equal to 95 mass % calcium carbonate), sand, crushed rocks, gravel, and mixtures thereof, or any other suitable material.

It is contemplated that the aggregate is configured to provide layer thickness, improve mixing, and/or limit segregation of the composition. The aggregate may further provide a rough surface that can increase the skid resistance of the composition. In an alternate embodiment, aggregate may be provided within the pothole prior to applying the quick setting polymer modified composition to the pothole and the pre-provided aggregate may be in place of or in addition to the aggregate within the polymer modified cement mixture.

According to some embodiments, the polymer modified cement mixture may optionally include microfibers. It is contemplated that the microfibers may be configured to limit segregation, limit shrinkage, limit exothermal generation, and improve workability. The microfibers may be polypropylene microfibers.

According to some embodiments, the polymer modified cement mixture may optionally include one or more plasticizers. It is contemplated that the plasticizer may be configured to increase workability. The plasticizers may be mineral admixtures (fly ash, metakaolin, and/or silica fume) or chemical admixtures (air-entrancing agents and/or water-reducers, such as superplasticizers).

According to some embodiments, the polymer modified cement mixture may optionally include one or more fillers. It is contemplated that the filler may be configured to enhance workability, limit segregation and shrinkage and increase long term compressive strength. The filler may be a pozzolanic filler, such as fly ash (e.g., class C or class F fly ash). A pozzolanic filler advantageously does not exhibit alkali silica reaction tendencies and improves the workability of the cement mixture.

According to some embodiments, the polymer modified cement mixture may optionally include one or more accelerators. It is contemplated that the accelerator may be configured to accelerate curing as may be needed for nighttime applications and time sensitive applications. The accelerators may be compounds such as calcium compounds, aluminum compounds, silicate, triethanolamine, carbonates, soluble chlorides, or fluorosilicates.

According to some embodiments, the polymer modified cement mixture may also optionally include one or more retarders. For example, the cement mixture may include an accelerator together with a retarder to delay the change in workability that comes from adding the accelerator. The retarders may include compounds such as calcium sulphate, acids (tartaric and citric), phosphonates, cellulose products (sucrose, glucose), sodium gluconate, Rochelle salt and cream of tartar, lignosulphonates, starches, hydroxycarboxylic acids, borates, and mixtures thereof.

According to some embodiments, the polymer modified cement mixture may optionally include one or more pigments for coloring. The pigments may include natural and synthetic pigments, such as but not limited to iron oxide, cobalt, titanium dioxide, and chromium oxide. Pigments may be utilized to color the quick setting polymer modified cement composition based on the color of the pavement substrate it is being applied to. That is, the pigments utilized may be to provide a quick setting polymer modified cement composition a color similar to the color of the pavement substrate it is being applied to.

As described above, the quick setting mixture may include a cementitious agent, preferably an amorphous cementitious agent. The cementitious agent may include calcium aluminate compounds, preferably amorphous calcium aluminate compounds. In some embodiments, the cementitious agent may include amorphous calcium aluminate compounds blended with calcium sulfate.

In some embodiments, the cementitious agent may include at least one amorphous compound selected from the group consisting of aluminum oxide, calcium oxide, and silicon dioxide. In preferred embodiments, the cementitious agent is an amorphous cementitious agent which includes aluminum oxide (e.g. between 10-40 wt. %, preferably between 15-30 wt. % based on the total weight of the cementitious agent), calcium oxide (e.g. between 20-60 wt. %, preferably between 30-50 wt. % based on the total weight of the cementitious agent), silicon dioxide (e.g. between 0.1-20 wt. %, preferably between 1-10 wt. % based on the total weight of the cementitious agent), and sulfur trioxide (e.g. between 10-50 wt. %, preferably between 20-40 wt. % based on the total weight of the cementitious agent). The cementitious agent may have a particle size diameter range with a D90 of less than 100 μm, preferably between 10-60 μm. The cementitious agent may further have particle size diameter range with a D50 of 1-25 μm, preferably between 2-15 μm.

In some embodiments, the cementitious agent may include an ettringite forming substance. Without intending to be bound to a particular theory, it is contemplated that formation of ettringite may play an important role in the setting of a polymer modified cement composition. An ettringite forming substance may therefore advantageously decrease the time needed for the mixture to set.

In some embodiments, the cementitious agent may have an inherent color (e.g., color prior to the addition of any pigments, dyes, or other coloring-agents) that is substantially white. Likewise, the cement (e.g., ordinary Portland cement) may have an inherent color that is substantially white or gray. It is therefore contemplated that the quick setting polymer modified cement composition may be substantially white. Such embodiments may be advantageous for applications in which a white-colored composition is preferred (e.g., repair of potholes in a cement pavement substrate).

As described above, the quick setting mixture may optionally include an aggregate and/or a polymer. The aggregate of the quick setting mixture may be the same as or different than the aggregate of the polymer modified cement mixture, and the polymer of the quick setting mixture may be the same as, or different than, the polymer of the polymer modified cement mixture.

It is contemplated that the quick setting mixture may be present in an amount between 6-25 wt. %, between 8-20 wt. %, or between 10-15 wt. % based on the total amount of the polymer modified cement mixture. It is contemplated that the amount of quick setting mixture, and particularly the amount of the cementitious agent, may vary depending on various factors, including but not limited to the type or source of ordinary Portland cement used in the polymer modified cement mixture, the temperature and humidity of the surrounding environment, the time of day, whether the substrate is wet or dry. One of ordinary skill in the art will understand that ordinary Portland cement may differ somewhat in composition from source to source, and will further understand that the relative amount of the quick setting mixture or the cementitious agent may be determined through evaluation of different amounts of the agent (e.g., beginning with 6 wt. % of the quick setting mixture and then adjusting upwards or downwards depending on results) from one batch of ordinary Portland cement to another.

In some embodiments, the quick setting polymer modified cement composition may be free or substantially free of lithium or lithium-containing compounds.

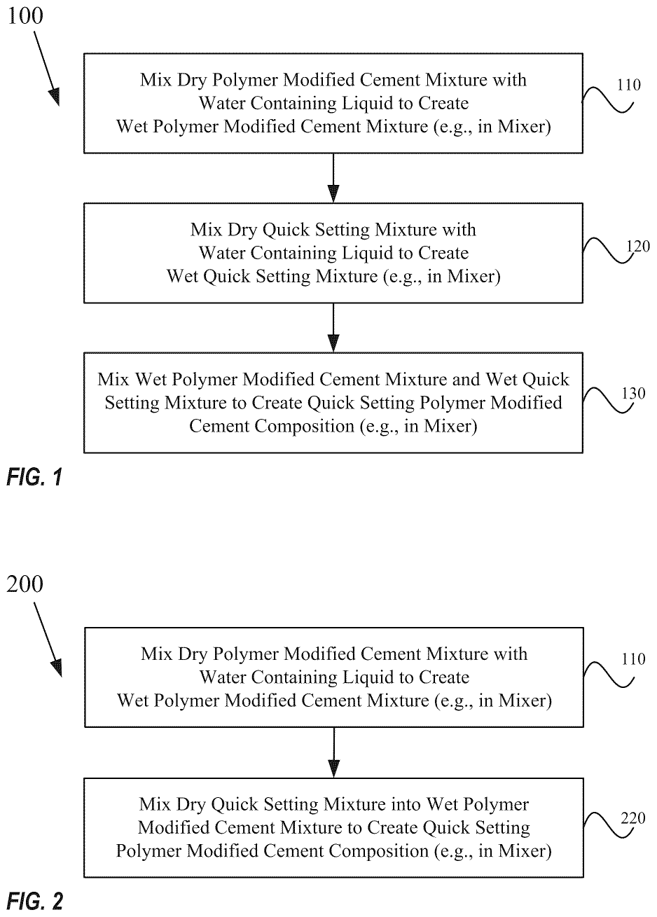

Present embodiments further relate to methods of forming a quick setting polymer modified cement composition. Methods may include preparing a wet (e.g., aqueous) polymer modified cement mixture and separately preparing a wet (e.g., aqueous) quick setting mixture and mixing the two wet mixtures. FIG. 1 illustrates an exemplary process 100 for preparing a quick setting polymer modified cement composition. In particular, a wet (e.g., aqueous) polymer modified cement mixture is prepared by combining a polymer modified cement mixture (dry mix) that includes cement (e.g., ordinary Portland cement), aggregate, polymer, and optionally one or more additional components, such as microfibers, plasticizers, fillers, accelerators, retarders, with a water-containing liquid 110. In some embodiments, the wet polymer modified cement mixture may be prepared by providing the components (e.g., dry mix and water) to a mixer. A wet (e.g., aqueous) quick setting mixture is prepared by combining the quick setting mixture (dry mix) that includes a cementitious agent (and optionally an aggregate and/or a polymer) with a water-containing liquid 120. In some embodiments, the wet quick setting mixture may be prepared by providing the components (e.g., dry mix and water) to a mixer.

The polymer modified cement composition may then be formed by contacting or combining an appropriate amount of the wet polymer modified cement mixture with an appropriate amount of the wet quick setting mixture 130. In some embodiments, the wet polymer modified cement mixture may be combined with the wet quick setting mixture via a mixer. It is contemplated that it is easier and faster to contact or combine the polymer modified cement mixture and quick setting mixture when in wet forms. It is further contemplated that the quick setting mixture may not begin to set when in an aqueous form alone, or that the quick setting mixture may set slowly when in an aqueous form alone, and it is not until the quick setting mixture is contacted or combined with the alkaline polymer modified cement mixture that its quick setting property advances.

In some embodiments, the wet polymer modified cement mixture and the wet quick setting mixture may be combined without using a mixer. Rather, the two wet mixtures may be applied via some type of applicators (e.g., spray nozzle, tube, extruder) that combine the wet mixtures during the application process. According to one embodiment, each of the wet mixes are disbursed separately into the pothole such that the wet mixtures are combined as they are provided to the pothole. The amount of each wet mixture that is provided to the pothole is controlled to ensure the appropriate amounts are used to prepare the composition. As the wet mixtures are not actively being mixed, it is possible that the quick setting functionality may not be evenly disbursed throughout the quick setting polymer modified cement composition that is created.

According to one embodiment, each of the wet mixtures may be sprayed via, for example, spray nozzles, into the pothole. According to one embodiment, the wet polymer modified cement mixture may be poured or extruded into the pothole and the wet quick setting mixture may be sprayed into the wet polymer modified cement mixture as it is being provided to the pothole. It should be noted that mixing in this fashion may be subject to the elements as wind or rain may affect the distribution of one or more of the wet mixtures and thus the quick setting properties of the resulting quick setting polymer modified cement composition.

Alternative methods may include preparing a wet (e.g., aqueous) polymer modified cement mixture and mixing a dry quick setting mixture thereinto. FIG. 2 illustrates an exemplary process 200 for preparing a quick setting polymer modified cement composition. Like the process 100, the process 200 includes preparing the wet (e.g., aqueous) polymer modified cement mixture by combining the polymer modified cement mixture (dry mix) with a water-containing liquid 110 (e.g., in a mixer). The polymer modified cement composition may then be formed by mixing an appropriate amount of the wet polymer modified cement mixture with an appropriate amount of the dry quick setting mixture 220. In some embodiments, the dry quick setting mixture may be added into the same mixer where the wet polymer modified cement mixture was prepared. In alternative embodiments, a portion of the wet polymer modified cement mixture prepared may be transferred to another mixer to be mixed with the dry quick setting mixture.

In some embodiments, the dry quick setting mixture may be added after the wet polymer modified cement mixture has been completely mixed. In alternative embodiments, the dry quick setting mixture may be added as the wet polymer modified cement mixture is being mixed. In some embodiments, the dry mix quick setting mixture may be added alone while in alternative embodiments additional water-containing liquid may be added as required. It is contemplated that the quick setting properties of the quick setting mixture begin once it is contacted or combined with the wet alkaline polymer modified cement mixture.

In some embodiments, the wet polymer modified cement mixture and the dry quick setting mixture may be combined without using a mixer. Rather, the two mixtures may be applied via some type of applicators (e.g., spray nozzle, tube, extruder) that combine the mixtures during the application process. According to one embodiment, each of the mixes are disbursed separately into the pothole such that the mixtures are combined as they are provided to the pothole. The amount of each wet mixture that is provided to the pothole is controlled to ensure the appropriate amounts are used to prepare the composition. As the mixtures are not actively being mixed, it is possible that the quick setting functionality may not be evenly disbursed throughout the quick setting polymer modified cement composition that is created. It is also possible that some of the dry quick setting agent may not be activated by the wet polymer modified cement mixture.

According to one embodiment, the wet polymer modified cement mixture may be sprayed via, for example, spray nozzles, into the pothole and the dry quick setting mixture may sprayed utilizing air or the like via, for example, spray nozzles. According to one embodiment, the wet polymer modified cement mixture may be poured or extruded into the pothole and the dry quick setting mixture may be sprayed into the wet polymer modified cement mixture as it is being provided to the pothole. It should be noted that mixing in this fashion may be subject to the elements as wind or rain may affect the distribution of one or more of the mixtures and thus the quick setting properties of the resulting quick setting polymer modified cement composition.

The polymer modified cement mixture and the quick setting mixture may be delivered to a site of application with all of their dry components mixed together, for example all components other than the water-containing liquids. The quick setting polymer modified cement composition may be prepared at the site prior to application according to, for example, process 100 or process 200. In some embodiments, the polymer modified cement mixture, the quick setting mixture and the water-containing liquids may be housed in a vehicle that brings the contents to the site. In some embodiments, a vehicle is utilized to prepare the quick setting polymer modified cement composition at the site. In some embodiments, a vehicle is utilized to apply the composition to the pothole. The same vehicle may house the contents, mix the contents and apply the contents. Alternatively, different vehicles may be used where each vehicle utilized performs a subset of the housing, mixing and applying.

Present embodiments further relate to methods of using a quick setting polymer modified cement composition to fix potholes in pavement substrates. The substrate may be any suitable surface on which the polymer modified cement composition may be applied, such as asphalt, concrete, or metal. For example, the substrate may include sealcoats; single chip, double chip or cape seals; all asphalt slurry types; all asphalt micro surfaces; thin hot mix flexible asphalt pavement surfaces with high surface deflections (≥0.8 mm deflection); thick hot mix flexible asphalt pavement surfaces with low surface deflections (≤0.8 mm deflection); all ordinary Portland cement concrete pavements; roller compacted concrete; and white topping. It is contemplated that the substrate may be wet or dry.

The polymer modified cement composition may be applied to one or more surfaces of the substrate using standard processes, such as via an extruder, ribbon, squeegee, screeder or sprayer (e.g., using a spray gun, or spray bar).

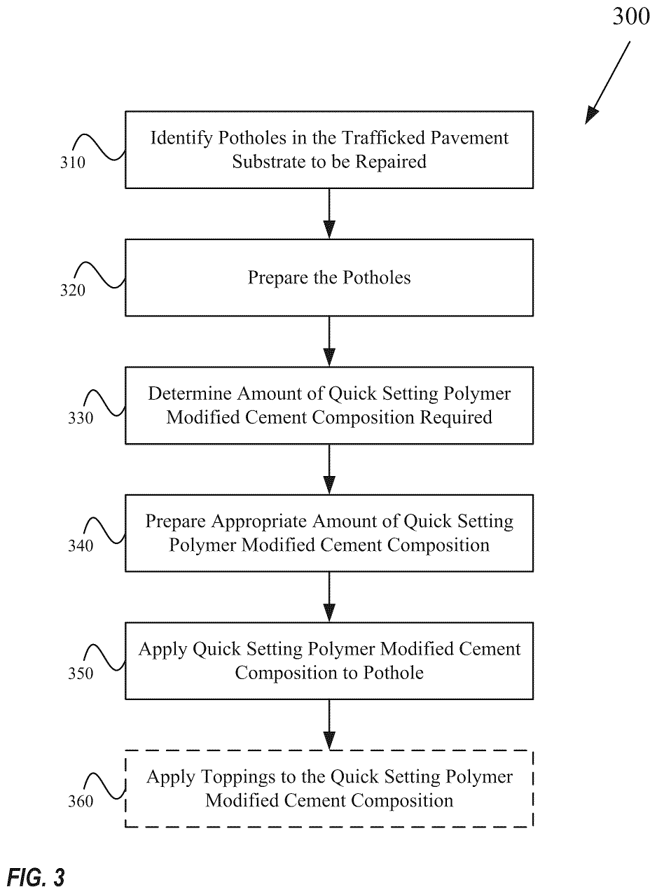

FIG. 3 illustrates an exemplary process flow 300 for applying a polymer modified cement composition to a substrate to pix potholes within the substrate. The process flow 300 may begin by identifying the potholes in the pavement substrate 310. The potholes may then be prepared to be fixed 320. The preparation of the potholes may include removing extraneous items including, but not limited to, dust, dirt, rocks, sticks, trash, pieces of substrate (e.g., asphalt, concrete) or other debris therefrom. The extraneous items may be removed with blowers (e.g., industrial blowers), by hand and/or with other devices. If the pothole includes rough edges and/or uneven surfaces, the preparation may include making adjustments (e.g., cutting, pounding) to the substrate around the pothole so that repairs can be made.

If the porthole is on, or in close proximity, to pavement markings, the pavement markings may be removed using an appropriate technique (e.g., shot blasting, high pressure water blasting, grinding). If the porthole and/or the surface of the substrate around the pothole is contaminated with soil, grease, or the like, the pothole and/or the surrounding surface may require pressure washing. The pothole and/or the surface of the substrate surrounding the pothole may further be dried. However, it is contemplated that the pothole and/or surface of the substrate therearound may be wet or dry prior to application of the quick setting polymer modified cement composition. If the pothole is deep, preparation may include partially filling the hole with aggregate (e.g., rocks, gravel) to limit the amount of quick setting polymer modified cement composition that will be required.

As the quick setting polymer modified cement composition will harden and/or cure very quickly, only an appropriate amount of quick setting polymer modified cement composition should be made as excess will need to be thrown away. Accordingly, a determination should be made as to the amount that will be required to fix the pothole 330. The determination may be made by measuring the size of the pothole, by filling the pothole with water or some other liquid to determine volume or by other means that would be known to those skilled in the art. The quick setting polymer modified cement composition is then prepared 340. The quick setting polymer modified cement composition may be prepared in different fashions including those described with respect to FIGS. 1 and 2.

The quick setting polymer modified cement composition may then be applied to the pothole in a trafficked pavement substrate 350. The quick setting polymer modified cement composition may be applied wet to the pothole so that it ensures an excellent initial and long-term bond. The quick setting polymer modified cement composition may be, for example, sprayed, poured, and/or manually applied (e.g., shoveled) into the pothole. According to one embodiment, the quick setting polymer modified cement composition may initially be sprayed to the sides of the pothole and then the pothole may be filled in with the quick setting polymer modified cement composition via, for example, pouring or manual application. The initial spraying of the pothole is to ensure all the surfaces of the pothole are adequately covered for good adhesion. The method of application may be dependent on different parameters including, but not limited to, size of the pothole, access to the pothole, equipment and personnel available. The quick setting polymer modified cement composition may be leveled off with a squeegee, trowel or the like after it is applied to the pothole.

Depending on the location of the pothole it may be desirable to have topical items applied to the quick setting polymer modified cement composition prior to the composition curing 360. According to one embodiment, the reason to add the topical items may be to provide a friction surface if the pothole is located in for example, a cross walk or a curved portion of the pavement substrate. The topical item utilized to provide a friction surface may be a topical aggregate including sand, gravel and/or stones, where the size and type of topical aggregate used is based on type of surface desired and availability of different kinds of topical aggregate. According to one embodiment, the reason to add the topical items may be to retroreflect lights from traffic traversing the pavement substrate. This may be desirable at dangerous curves or for road markings. The topical items utilized to retroreflect light may be glass beads.

The topical items may be provided to the quick setting polymer modified cement composition that was used in the pothole soon after (e.g., almost immediately) the quick setting polymer modified cement composition is applied. The topical items may be dropped and/or broadcast from a vehicle or may be manually applied (e.g., by hand, by shovel, by spreader).

According to one embodiment, a vehicle may be utilized to spray and/or pour the quick setting polymer modified cement composition into the pothole. For example, the vehicle may have one or more nozzles to spray the quick setting polymer modified cement composition and/or one or more tubes to pour the quick setting polymer modified cement composition. In some embodiments, the vehicle may house the wet polymer modified cement mixture and the quick setting mixture in dry or wet form and provide a location for mixing the two. In some embodiments, the vehicle may house the dry polymer modified cement mixture, the dry quick setting mixture and water and provide mixers for preparing the wet polymer modified cement mixture and the quick setting polymer modified cement composition.

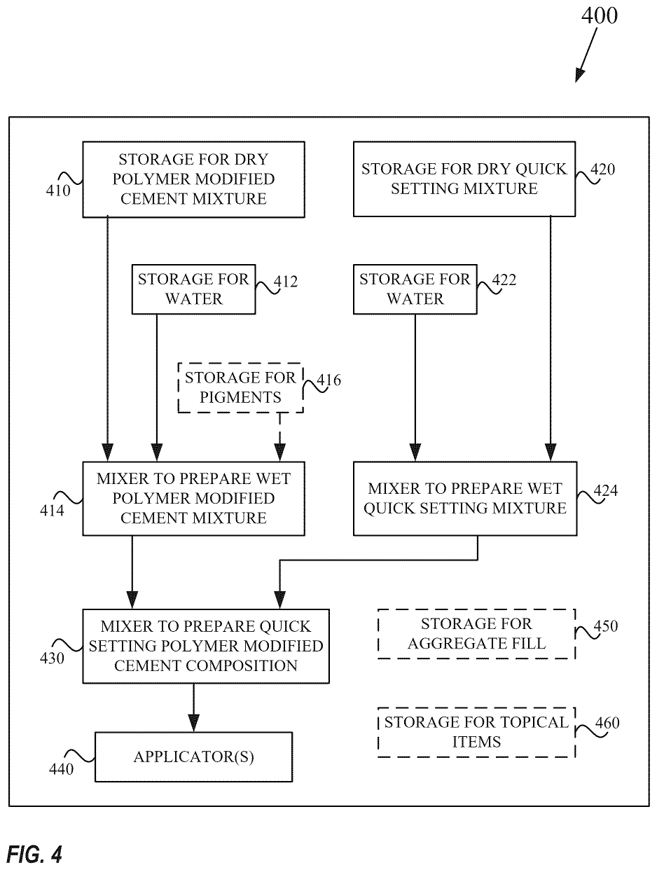

FIG. 4 illustrates an exemplary vehicle (e.g., truck) 400 configured to house components necessary to prepare a quick setting polymer modified cement composition and apply it to potholes. The vehicle 400 may be designed to prepare the quick setting polymer modified cement composition according to the process described with respect to FIG. 1. The vehicle 400 may include a first storage or housing 410 to house the dry polymer modified cement mixture and a second storage or housing 420 to house the dry quick setting mixture. The vehicle 400 may further include a storage or housing 412 to house a first water containing liquid and a storage or housing 422 to house a second water containing liquid. The vehicle 400 may also include a mixer 414 to combine the dry polymer modified cement mixture with the first water containing liquid to form a wet polymer modified cement mixture, and a mixer 424 to combine the dry quick setting mixture with the second water containing liquid to form a wet quick setting mixture.

According to an embodiment where the first water containing liquid and the second water containing liquid are the same, a single storage or housing may be utilized to store the water containing liquid. The single storage or housing may provide an appropriate amount of the water containing liquid to each mixer 414, 424. The vehicle 400 may further include one or more mixers 430 to mix the wet polymer modified cement mixture and the wet quick setting mixture to create the quick setting polymer modified cement composition. For example, the one or more mixers 430 may include a series of baffles or fins configured to sufficiently mix the wet mixtures and create the quick setting polymer modified cement composition. The one or more mixers 430 may then feed the quick setting polymer modified cement composition to one or more applicators 440 configured to provide the quick setting polymer modified cement composition into the pothole(s). According to one embodiment, the one or more applicators 440 may be, for example, one or more spray nozzles capable of spraying the quick setting polymer modified cement composition into the pothole. According to some embodiments, the one or more applicators 440 may be, for example, one or more tubes for pouring or one or more extruders for extruding. According to one embodiment, the one or more applicators 440 may include different types of applicators. The one or more mixers 430 may be located upstream of the one or more applicators 440. In a preferred embodiment, the one or more mixers 430 may be located immediately upstream from the one or more applicators 440.

According to one embodiment, the vehicle 400 may optionally include one or more storage units or housings 416 for storing one or more pigments. The pigments could be utilized to match the color of the quick setting polymer modified cement composition to the color of the pavement substrate that the pothole is located within. For example, if most of the pothole repairs are for a substantially white pavement substrate the resulting color of the quick setting polymer modified cement composition would be substantially white. However, if one of the potholes being fixed is in a green bike lane it may be desirable to prepare a batch of quick setting polymer modified cement composition that is green. According to one embodiment, to create a green quick setting polymer modified cement composition an appropriate amount of green pigment from an appropriate storage unit or housing 416 may be added into the mixer 414. The addition of the green pigment would create a wet green polymer modified cement mixture that when combined with the wet quick set mixture would provide the green quick setting polymer modified cement composition. According to an alternative embodiment, the green pigment may be provided to the mixer 424 in addition to the mixer 414 or instead of the mixer 414.

According to one embodiment, the vehicle 400 may optionally include one or more storage units or housings 450 for storing one or more types of aggregate to be used as fill in the event the potholes are large. As discussed above, if the pothole is large, aggregate (e.g., rocks, gravel) may be used to fill at least a portion of the hole prior filling the hole with the quick setting polymer modified cement composition. According to one embodiment, the pothole may initially be coated with a layer (e.g., thin layer) of the quick setting polymer modified cement composition for adhesion, then filled with aggregate, and then topped off with the quick setting polymer modified cement composition for completing the repair.

If it is determined that the pothole being fixed should partially be filled with aggregate, an appropriate aggregate will be used from an appropriate storage unit or housing 450. According to one embodiment, the storage unit or housing 450 may be connected to a tube or the like that can provide the aggregate to the pothole. According to one embodiment, the storage unit or housing 450 may simply open to dump the appropriate amount of aggregate into the pothole or into a wheel barrel or the like that can be moved to the pothole and allow the aggregate to be provided (e.g., dumped, shoveled) into the pothole. According to one embodiment, the storage unit or housing 450 may simply open to enable a user to obtain an appropriate amount of aggregate to provide to the pothole.

According to one embodiment, the vehicle 400 may optionally include one or more storage units or housings 460 for storing one or more types of topical items to be applied to the quick setting polymer modified cement composition provided in the pothole prior to curing. As discussed above, if the pothole is located in an area where friction or retroreflecting is desired it may be desirable to provide topical aggregate or glass beads to the quick setting polymer modified cement composition prior to curing. If it is determined that the pothole being fixed should have a friction surface, an appropriate topical aggregate will be used from an appropriate storage unit or housing 460. According to one embodiment, the storage unit or housing 460 may be connected to a broadcaster or the like that can provide the topical aggregate to the quick setting polymer modified cement composition. According to one embodiment, the storage unit or housing 460 may simply open to dump the appropriate amount of topical aggregate (e.g., directly onto the quick setting polymer modified cement composition or into a wheel barrel, broadcaster or the like that can provide the topical aggregate onto the quick setting polymer modified cement composition). According to one embodiment, the storage unit or housing 460 may simply open to provide access thereto.

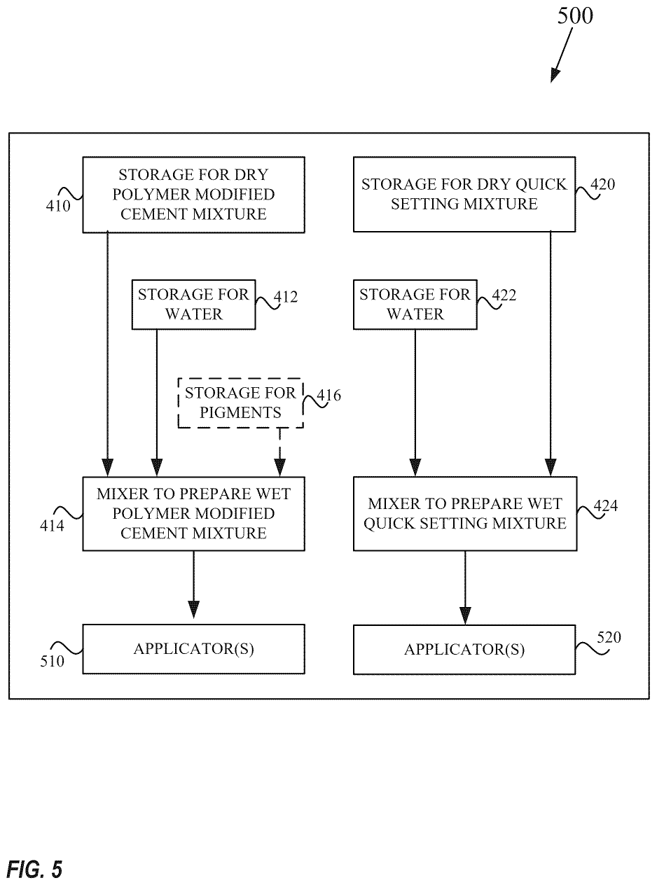

FIG. 5 illustrates an exemplary vehicle 500 configured to house components necessary to prepare a quick setting polymer modified cement composition and apply it to potholes. The vehicle 500 may be designed to prepare the quick setting polymer modified cement composition according to the process described with respect to FIG. 1. The exemplary vehicle 500 includes many of the same components as the exemplary vehicle 400 so like items will be identified with the same reference numbers and the components previously discussed will not be discussed in detail or at all. It should be noted that the vehicle 500 does not illustrate the optional storage units or housings 450, 460 for storing aggregate fill or topical items for ease of illustration. These items may optionally be included.

The vehicle 500 does not include one or more mixers 430 for combining the two wet mixtures. Rather, the wet mixes from each of the mixers 414, 424 are provided to one or more applicators 510, 520. The applicator(s) 510 may include, for example, one or more spay nozzles, extruders and/or tubes for providing the wet polymer modified cement mixture to the pothole. The applicator(s) 520 may include, for example, one or more spray nozzles or the like capable of contacting the wet polymer modified cement mixture with the wet quick setting mixture as the wet polymer modified cement mixture is being provided to the pothole.

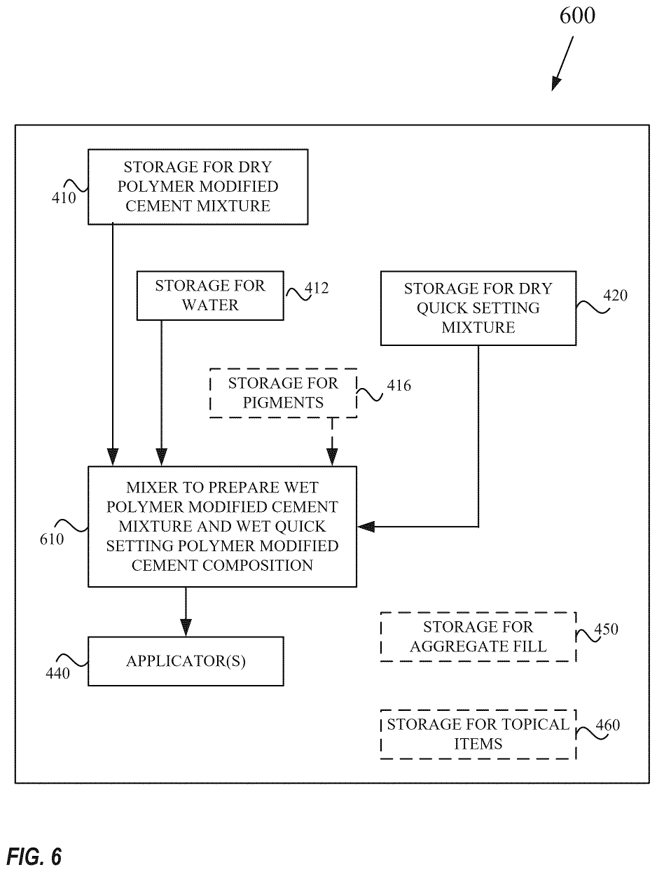

FIG. 6 illustrates an exemplary vehicle 600 configured to house components necessary to prepare a quick setting polymer modified cement composition and apply it to potholes. The vehicle 600 may be designed to prepare the quick setting polymer modified cement composition according to the process described with respect to FIG. 2. The exemplary vehicle 600 includes many of the same components as the exemplary vehicle 400 so like items will be identified with the same reference numbers and the components previously discussed will not be discussed in detail, or at all.

The vehicle 600 includes a mixer 610 that is used to prepare both the wet polymer modified cement mix and the quick setting polymer modified cement composition. Initially the mixer 610 prepares the wet polymer modified cement mix by mixing the water containing liquid from the storage 412 and the dry polymer modified cement mix from the storage 410 (and optionally the pigment). Once the wet polymer modified cement mix is prepared (adequate mixing of the water containing liquid and the dry polymer modified cement mix) and it is desired to apply the quick setting polymer modified cement composition, the dry quick setting mixture from the storage 420 will be added to the mixer 610. The mixer 610 will be capable of mixing the dry quick setting mixture and the wet polymer modified cement mix. The time it takes to adequately mix the dry quick setting mixture and the wet polymer modified cement mix has to be relatively quick as once the two are mixed the quick setting properties are activated. According to one embodiment, additional water containing liquid from the storage 412 may be added at this point if desired and/or required.

Any quick setting polymer modified cement composition left in the mixer after application to the pothole, or any quick setting polymer modified cement composition that sets prior to application will need to be discarded. Accordingly, it is desirable to prepare only as much of the composition as required/desired. Limiting the amount of wet polymer modified cement mixture to the amount desired for a specific pothole may slow down the time it takes to repair a pothole. According to one embodiment, it would be desirable to have additional wet polymer modified cement mixture prepared and only prepare the amount of quick setting polymer modified cement composition as required/desired for a specific pothole. According to one embodiment, the mixer 610 may include two parts where a first part can be used to prepare wet polymer modified cement mixture and a second part that can receive an appropriate amount of wet polymer modified cement mixture from the first part and also an appropriate amount of dry quick setting mixture and mix those accordingly. Alternatively, two separate mixers may be used.

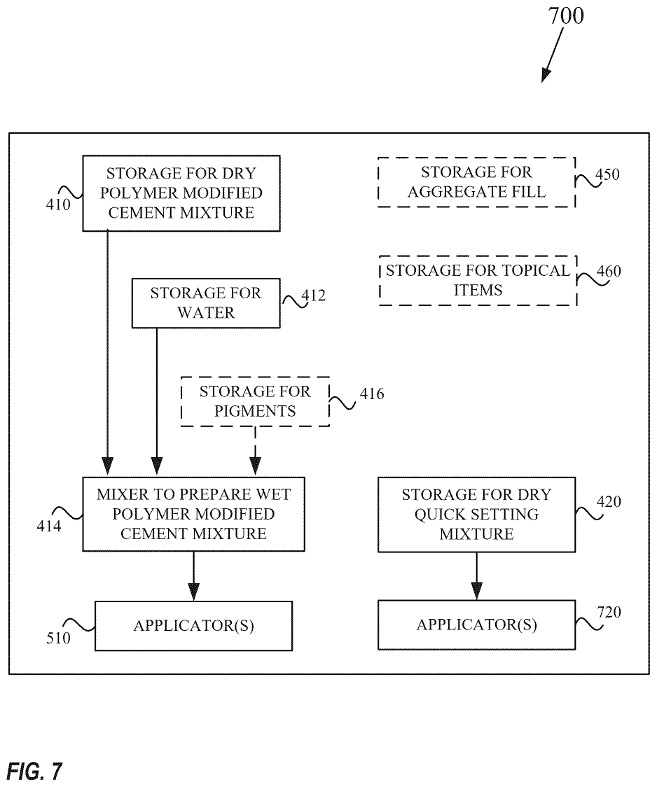

FIG. 7 illustrates an exemplary vehicle 700 configured to house components necessary to prepare a quick setting polymer modified cement composition and apply it to potholes. The vehicle 700 may be designed to prepare the quick setting polymer modified cement composition according to the process described with respect to FIG. 2. The exemplary vehicle 600 includes many of the same components as the exemplary vehicle 400 so like items will be identified with the same reference numbers and the components previously discussed will not be discussed in detail, or at all.

The vehicle 700 does not include the one or more mixers 610 for combining the wet polymer modified cement mixture and the dry quick setting mixture. Rather, the wet polymer modified cement mixture is prepared in the mixer 414 and provided to one or more applicators 510. The one or more applicators 510 may include, for example, one or more spay nozzles, extruders and/or tubes for providing the wet polymer modified cement mixture to the pothole. The dry quick setting mixture is provided to one or more applicators 720 that may include, for example, one or more spray nozzles or the like capable of contacting the wet polymer modified cement mixture with the dry quick setting mixture as the wet polymer modified cement mixture is being provided to the pothole.

It is contemplated that the quick setting polymer modified cement composition provided to fix the pothole may be traffic-ready (or workable) within thirty minutes of application, preferably within fifteen minutes of application, more preferably within 10 minutes of application, most preferably within 5 minutes or within 1 minute of application. These times generally are reproducible even at surface temperatures below 40 degrees F., such as below 35 degrees F. Furthermore, these times are generally reproducible for pothole fixes of various sizes. The amount of quick setting polymer modified cement composition utilized does not greatly impact the time to be traffic ready. The term “traffic ready” or “workable” means that the quick setting polymer modified cement composition within the pothole is able to withstand vehicular traffic without the overlay tracking/adhering to tires of a vehicle traveling on the overlay.

It is contemplated that time before which the composition may be traffic-ready or workable is dependent in part on the amount of the quick setting mixture, and specifically the amount of cementitious agent, present in the composition. For example, generally the time before which the composition may be traffic-ready or workable is directly proportional to the amount of cementitious agent present in the composition.

It is contemplated that the composition may be resistant to traffic-based degradation. It is further contemplated that the composition may be weather resistant and durable with a long-life cycle of a decade or more once applied to the substrate to fix the pothole.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some, or all the features, of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A method for fixing potholes in a pavement substrate configured for vehicular transportation, the method comprising:
preparing a wet polymer modified cement mixture by mixing a dry polymer modified cement mixture comprising a cement, an aggregate, and a polymer in particulate form with a water-containing liquid;
preparing a quick setting polymer modified cement composition by mixing the wet polymer modified cement mixture and a quick setting cementitious agent mixture, wherein alkalinity of the wet polymer modified cement mixture initiates quick setting properties of the quick setting cementitious agent mixture; and
providing the quick setting polymer modified cement composition into the potholes.

2. The method of claim 1, wherein the quick setting polymer modified cement composition provided into the pothole is traffic ready within fifteen minutes of application.

3. The method of claim 1, wherein the quick setting polymer modified cement composition provided into the pothole is traffic ready within ten minutes of application.

4. The method of claim 1, wherein the quick setting polymer modified cement composition provided into the pothole is traffic ready within one minute of application.

5. The method of claim 1, wherein the quick setting cementitious agent mixture comprises a calcium aluminate compound.

6. The method of claim 1, wherein the quick setting cementitious agent mixture is amorphous.

7. The method of claim 6, wherein the amorphous quick setting cementitious agent mixture comprises at least one amorphous compound selected from the group consisting of aluminum oxide, calcium oxide, and silicon dioxide.

8. The method of claim 6, wherein the amorphous quick setting cementitious agent mixture is an amorphous calcium aluminate compound.

9. The method of claim 1, wherein the preparing the quick setting polymer modified cement composition includes mixing the wet polymer modified cement mixture and a dry quick setting cementitious agent mixture.

10. The method of claim 9, wherein the preparing the quick setting polymer modified cement composition includes mixing the wet polymer modified cement mixture and the dry quick setting cementitious agent mixture in a mixer.

11. The method of claim 9, wherein the preparing the quick setting polymer modified cement composition includes providing the dry quick setting cementitious agent mixture into the wet polymer modified cement mixture as the wet polymer modified cement mixture is provided into the pothole.

12. The method of claim 1, further comprising preparing a wet quick setting cementitious agent mixture by mixing a dry quick setting cementitious agent mixture with a water-containing liquid, and wherein the preparing the quick setting polymer modified cement composition includes mixing the wet polymer modified cement mixture and the wet quick setting cementitious agent mixture.

13. The method of claim 12, wherein the preparing the quick setting polymer modified cement composition includes mixing the wet polymer modified cement mixture and the dry quick setting cementitious agent mixture in a mixer.

14. The method of claim 12, wherein the preparing the quick setting polymer modified cement composition includes providing the wet quick setting cementitious agent mixture into the wet polymer modified cement mixture as the wet polymer modified cement mixture is provided into the pothole.

15. The method of claim 1, wherein the preparing the quick setting polymer modified cement composition and the providing the quick setting polymer modified cement composition into the potholes are performed together and include providing the quick setting cementitious agent mixture into the wet polymer modified cement mixture as the wet polymer modified cement mixture is provided into the pothole.

16. The method of claim 15, wherein the providing the quick setting cementitious agent mixture into the wet polymer modified cement mixture as the wet polymer modified cement mixture is provided into the pothole includes providing a dry quick setting cementitious agent mixture into the wet polymer modified cement mixture as the wet polymer modified cement mixture is provided into the pothole.

17. The method of claim 15, further comprising preparing a wet quick setting cementitious agent mixture by mixing a dry quick setting cementitious agent mixture with a water-containing liquid, and wherein the providing the quick setting cementitious agent mixture into the wet polymer modified cement mixture as the wet polymer modified cement mixture is provided into the pothole includes providing the wet quick setting cementitious agent mixture into the wet polymer modified cement mixture as the wet polymer modified cement mixture is provided into the pothole.

18. The method of claim 1, wherein providing the quick setting polymer modified cement composition into the potholes includes spraying the quick setting polymer modified cement composition into the potholes.

19. The method of claim 1, wherein providing the quick setting polymer modified cement composition into the potholes includes pouring the quick setting polymer modified cement composition into the potholes.

20. The method of claim 1, wherein the dry polymer modified cement mixture further comprises a pigment.

21. The method of claim 1, wherein the preparing the wet polymer modified cement mixture includes mixing the dry polymer modified cement mixture, a pigment and the water-containing liquid.

22. The method of claim 1, further comprising applying topical items onto the quick setting polymer modified cement composition provided into the potholes.

23. A method for fixing potholes in a pavement substrate configured for vehicular transportation, the method comprising:
identifying the potholes in the pavement substrate;
preparing the potholes for repair;
preparing an appropriate amount of a quick setting polymer modified cement composition that comprises a wet polymer modified cement mixture and a quick setting cementitious agent mixture, wherein the wet polymer modified cement mixture includes cement, an aggregate, a polymer in particulate form and a water-containing liquid, and wherein alkalinity of the wet polymer modified cement mixture initiates quick setting properties of the quick setting cementitious agent mixture; and
providing the quick setting polymer modified cement composition into the potholes.

24. The method of claim 23, wherein the preparing the potholes includes providing aggregate fill into large potholes.

25. The method of claim 23, wherein the quick setting polymer modified cement composition provided into the pothole is traffic ready within fifteen minutes of application.

26. The method of claim 23, wherein the quick setting cementitious agent mixture comprises an amorphous calcium aluminate compound.

27. The method of claim 23, wherein the preparing the appropriate amount of the quick setting polymer modified cement composition includes mixing the wet polymer modified cement mixture and the quick setting cementitious agent mixture in a mixer.

28. The method of claim 23, wherein the preparing the appropriate amount of the quick setting polymer modified cement composition includes providing the quick setting cementitious agent mixture into the wet polymer modified cement mixture as the wet polymer modified cement mixture is provided into the pothole.

29. The method of claim 23, wherein the preparing the appropriate amount of the quick setting polymer modified cement composition and the providing the quick setting polymer modified cement composition into the potholes are performed together and include providing the quick setting cementitious agent mixture into the wet polymer modified cement mixture as the wet polymer modified cement mixture is provided into the pothole.

30. The method of claim 23, wherein providing the quick setting polymer modified cement composition into the potholes includes spraying the quick setting polymer modified cement composition into the potholes.

31. The method of claim 23, wherein providing the quick setting polymer modified cement composition into the potholes includes pouring the quick setting polymer modified cement composition into the potholes.

32. A vehicle for preparing and applying a quick setting polymer modified cement composition for fixing potholes in a pavement substrate configured for vehicular transportation, the vehicle comprising:
a first storage to house a dry polymer modified cement mixture comprising a cement, an aggregate, and a polymer in particulate form;
a second storage to house a dry quick setting cementitious agent mixture;
a third storage to house a water-containing liquid;
a first mixer to prepare a wet polymer modified cement mixture by mixing the dry polymer modified cement mixture and the water-containing liquid; and
one or more applicators to provide material into the potholes.

33. The vehicle of claim 32, wherein the one or more applicators include a first set of one or more applications and a second set of one or more applications, wherein the first set of one or more applications is to provide the wet polymer modified cement mixture into the potholes and the second set of one or more applications is to provide the dry quick setting cementitious agent mixture into the wet polymer modified cement mixture as it is being provided into the pothole.

34. The vehicle of claim 32, further comprising a second mixer to prepare a wet quick setting cementitious agent mixture by mixing the dry quick setting cementitious agent mixture and the water-containing liquid.

35. The vehicle of claim 34, wherein the one or more applicators include a first set of one or more applications and a second set of one or more applications, wherein the first set of one or more applications is to provide the wet polymer modified cement mixture into the potholes and the second set of one or more applications is to provide the wet quick setting cementitious agent mixture into the wet polymer modified cement mixture as it is being provided into the pothole.

36. The vehicle of claim 34, further comprising a third mixer to prepare the quick setting polymer modified cement composition by mixing the wet polymer modified cement mixture and the wet quick setting cementitious agent mixture.

37. The vehicle of claim 36, wherein the one or more applicators are to provide the quick setting polymer modified cement composition into the potholes.

38. The vehicle of claim 32, further comprising a second mixer to prepare the quick setting polymer modified cement composition by mixing the wet polymer modified cement mixture and the dry quick setting cementitious agent mixture.

39. The vehicle of claim 38, wherein the one or more applicators are to provide the quick setting polymer modified cement composition into the potholes.

40. The vehicle of claim 38, wherein the first and the second mixer are a single mixer utilized to prepare the wet polymer modified cement mixture first and then the quick setting polymer modified cement composition.

41. The vehicle of claim 32, further comprising a fourth storage to store one or more pigments.

42. The vehicle of claim 32, further comprising a fourth storage to store one or more topical items.
